(19) United States
(12) Patent Application Publication
(10) Pub. No.: US 2017/0192954 A1
(43) Pub. Date: Jul. 6, 2017

(54) Legacy Synchronous Communication System

(71) Applicant: Infinite Corporation, Laguna Niguel, CA (US)

(72) Inventor: Ronald B. Acacio, Fallbrook, CA (US)

(21) Appl. No.: 15/395,915

(22) Filed: Dec. 30, 2016

Related U.S. Application Data
(60) Provisional application No. 62/272,990, filed on Dec. 30, 2015.

(51) Int. Cl. G06F 17/24; G06F 17/22; H04L 29/06

(52) U.S. Cl. CPC G06F 17/248; H04L 67/42; G06F 17/2247

(57) ABSTRACT

A legacy synchronous communication system for dynamically reading a synchronous data stream and sending it to an asynchronous platform to be interpreted natively by a Java-based program. The legacy synchronous communication system generally includes a communications module configured to establish communications with a host server, a recognition module configured to identify the green screen objects in the data stream from the host and transform them into XML object, and a render module configured to present the XML objects through a browser on a user's computing device. The user's computing device (also referred to herein as a “client”) may be any computing device which supports a web browser, including, without limitation, desktop and notebook computers, workstations, and mobile devices, such as smartphones and tablet computers.

### CROSS REFERENCE TO RELATED APPLICATIONS

I hereby claim benefit under Title 35, United States Code, Section 119(e) of U.S. provisional patent application Ser. No. 62/272,990 filed Dec. 30, 2015 (Attorney Docket No. INFI-011). The 62/272,990 application is currently pending. The 62/272,990 application is hereby incorporated by reference into this application.

### STATEMENT REGARDING FEDERALLY SPONSORED RESEARCH OR DEVELOPMENT

Not applicable to this application.

### BACKGROUND

Field

Example embodiments in general relate to a legacy synchronous communication system for dynamically reading a synchronous data stream and sending it to an asynchronous platform to be interpreted natively by a Java-based program.

Related Art

Any discussion of the related art throughout the specification should in no way be considered as an admission that such related art is widely known or forms part of common general knowledge in the field.

Numerous businesses continue to use older computing systems, such as the IBM AS400 host servers, which were designed to communicate through a synchronous “5250” data stream with basic terminals. FIG. 1 is a simplified block diagram of such a system having a host server 10 in communication with a terminal 12. Such terminals typically display information as text only on a black background. Because the text was green, the terminals were nicknamed “green screen” terminals. An example is illustrated in FIG. 2.

Green screen terminals have given way to browser-based computing with graphical displays. However, many companies do not wish to migrate from their older systems in which they have invested significant amounts of time, money, and training and which represent their established business practices. For these companies, the older (“legacy”) systems still do the job they were intended to do. However, because green screens are unattractive and not user-friendly, some companies desire to upgrade the front end of their systems by sending the data stream to web-based platforms, such as Apache/Tomcat. Web-based platforms may provide greater access to the applications hosted on the legacy servers or migrated platforms and provide a more efficient and pleasant experience for the end user.

One method of enabling a web-based platform to interact with a legacy system is to re-code each of the green screens into a graphical format. This is an extremely time-consuming process. A typical AS400 application may have as many as 6,000 different screens that provide information to, or receive input from, the user. Re-coding that many screens may take years to complete. Consequently, a company may only recode just the most-often or most important screens, a process that may still take many months. Furthermore, the data stream to and from the host server is processed through software installed on each local device, and the processing and graphical rendering of the screens may become so slow that the applications become almost unusable, negating the intended effort.

A further disadvantage of some methods is that they are designed to run on only a single platform, such as small-scale Microsoft® Windows® devices, limiting their use.

### SUMMARY

An example embodiment of the present invention is directed to a legacy synchronous communication system. The legacy synchronous communication system includes a communications module configured to establish communications with a host server, a recognition module configured to identify the green screen objects in the data stream from the host and transform them into XML object, and a render module configured to present the XML objects through a browser on a user's computing device.

There has thus been outlined, rather broadly, some of the features of the legacy synchronous communication system in order that the detailed description thereof may be better understood, and in order that the present contribution to the art may be better appreciated. There are additional features of the legacy synchronous communication system that will be described hereinafter and that will form the subject matter of the claims appended hereto. In this respect, before explaining at least one embodiment of the legacy synchronous communication system in detail, it is to be understood that the legacy synchronous communication system is not limited in its application to the details of construction or to the arrangements of the components set forth in the following description or illustrated in the drawings. The legacy synchronous communication system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is simplified block diagram of a prior art synchronous computing system.

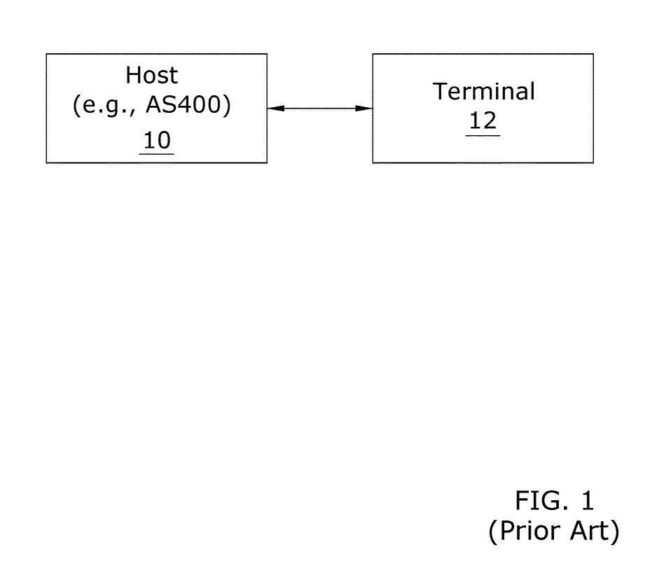

FIG. 2 is a screen shot of an example of a host sign-in green screen displayed on a terminal in communication with the prior art system of FIG. 1.

FIG. 3 is a simplified block diagram of a legacy synchronous communication system in accordance with an example embodiment.

FIG. 4 illustrates the Java® classes that are used to organize the data stream from a synchronous host, such as an IBM AS400.

FIG. 5 is a screen shot of the example host sign-in page of FIG. 2 after being processed and rendered by the legacy synchronous communication system of FIG. 3 with an example embodiment and displayed in graphical format in a browser.

FIG. 6 is a screen shot of an example agent panel.

FIG. 7 is a screen shot of another example agent panel.

FIG. 8 is a screen shot of a green screen main menu displayed on a terminal in communication with the prior art system of FIG. 1.

FIG. 9 is a screen shot of the menu page of FIG. 8 after being processed and rendered by the legacy synchronous communication system of FIG. 3 and displayed in graphical format in a browser.

FIG. 10 is a flowchart of an example method of setting up the legacy synchronous communication system of FIG. 3.

FIG. 11 is a screen shot of an example system sign-in page rendered by the legacy synchronous communication system of FIG. 3.

FIG. 12 is a screen shot of an example drop-down menu rendered by the legacy synchronous communication system of FIG. 3.

FIG. 13 is a screen shot of an example of a system settings panel for the legacy synchronous communication system of FIG. 3.

FIG. 14 is a screen shot of another example of a system settings panel for the legacy synchronous communication system of FIG. 3.

FIG. 15 is a flowchart of an example method of operating the legacy synchronous communication system of FIG. 3.

FIG. 16 is a screen shot of an example of a customer list rendered by the legacy synchronous communication system of FIG. 3.

FIG. 17 is a screen shot of the green screen equivalent of the customer list of FIG. 16.

FIG. 18 is a screen shot of an example of a drop down menu rendered by the legacy synchronous communication system of FIG. 3.

### DETAILED DESCRIPTION

### A. Overview.

Purpose of Invention:

To capture and read host communications from the IBM i and/or Infinite I on Apache/Tomcat.

Brief Description of Invention:

This toolset dynamically captures and reads the synchronous data stream from the IBM I or Infinite I system and delivers it to an Apache/Tomcat server.

Description of Problem(s) Solved by Invention:

This invention allows the synchronous data stream to be captured and read by an asynchronous platform, Apache/Tomcat so that it can later be interpreted natively by a Java-based program.

How the Invention is an Improvement Over Existing Technology:

This invention allows the synchronous data stream to be captured and read by a natively asynchronous platform like Apache/Tomcat. Once captured and read it can be interrogated by Java-based applications.

Groups of People and/or Businesses that would Use the Invention:

Businesses that have these systems and wish to send the data stream to a web-based platform like Apache/Tomcat can provide greater access to their applications hosted on legacy servers or migrated platforms.

Benefits to Users of Invention:

Faster processing, more open technology, modern structure and easier integration with other applications.

### B. Exemplary Telecommunications Networks.

The legacy synchronous communication system may be utilized upon any telecommunications network capable of transmitting data including voice data and other types of electronic data. Examples of suitable telecommunications networks for the legacy synchronous communication system include but are not limited to global computer networks (e.g. Internet), wireless networks, cellular networks, satellite communications networks, cable communication networks (via a cable modem), microwave communications network, local area networks (LAN), wide area networks (WAN), campus area networks (CAN), metropolitan-area networks (MAN), and home area networks (HAN). The legacy synchronous communication system may communicate via a single telecommunications network or multiple telecommunications networks concurrently. Various protocols may be utilized by the electronic devices for communications such as but not limited to HTTP, SMTP, FTP and WAP (wireless Application Protocol). The legacy synchronous communication system may be implemented upon various wireless networks such as but not limited to 3G, 4G, LTE, CDPD, CDMA, GSM, PDC, PHS, TDMA, FLEX, REFLEX, IDEN, TETRA, DECT, DATATAC, and MOBITEX. The legacy synchronous communication system may also be utilized with online services and internet service providers.

The Internet is an exemplary telecommunications network for the legacy synchronous communication system. The Internet is comprised of a global computer network having a plurality of computer systems around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

### C. Central Communication Unit.

The central communication unit may be comprised of any central communication site where communications are preferably established with. The central communication units may be comprised of a server computer, cloud based computer, virtual computer, home computer or other computer system capable of receiving and transmitting data via IP networks and the telecommunication networks. As can be appreciated, a modem or other communication device may be required between each of the central communication units and the corresponding telecommunication networks. The central communication unit may be comprised of any electronic system capable of receiving and transmitting information (e.g. voice data, computer data, etc.).

### D. Mobile Device.

The mobile device may be comprised of any type of computer for practicing the various aspects of the legacy synchronous communication system. For example, the mobile device can be a personal computer (e.g. APPLE® based computer, an IBM based computer, or compatible thereof) or tablet computer (e.g. IPAD®). The mobile device may also be comprised of various other electronic devices capable of sending and receiving electronic data including but not limited to smartphones, mobile phones, telephones, personal digital assistants (PDAs), mobile electronic devices, handheld wireless devices, two-way radios, smart phones, communicators, video viewing units, television units, television receivers, cable television receivers, pagers, communication devices, and digital satellite receiver units.

The mobile device may comprised of any conventional computer. A conventional computer preferably includes a display screen (or monitor), a printer, a hard disk drive, a network interface, and a keyboard. A conventional computer also includes a microprocessor, a memory bus, random access memory (RAM), read only memory (ROM), a peripheral bus, and a keyboard controller. The microprocessor is a general-purpose digital processor that controls the operation of the computer. The microprocessor can be a single-chip processor or implemented with multiple components. Using instructions retrieved from memory, the microprocessor controls the reception and manipulations of input data and the output and display of data on output devices. The memory bus is utilized by the microprocessor to access the RAM and the ROM. RAM is used by microprocessor as a general storage area and as scratch-pad memory, and can also be used to store input data and processed data. ROM can be used to store instructions or program code followed by microprocessor as well as other data. A peripheral bus is used to access the input, output and storage devices used by the computer. In the described embodiments, these devices include a display screen, a printer device, a hard disk drive, and a network interface. A keyboard controller is used to receive input from the keyboard and send decoded symbols for each pressed key to microprocessor over bus. The keyboard is used by a user to input commands and other instructions to the computer system. Other types of user input devices can also be used in conjunction with the legacy synchronous communication system. For example, pointing devices such as a computer mouse, a track ball, a stylus, or a tablet to manipulate a pointer on a screen of the computer system. The display screen is an output device that displays images of data provided by the microprocessor via the peripheral bus or provided by other components in the computer. The printer device when operating as a printer provides an image on a sheet of paper or a similar surface. The hard disk drive can be utilized to store various types of data. The microprocessor together with an operating system operate to execute computer code and produce and use data. The computer code and data may reside on RAM, ROM, or hard disk drive. The computer code and data can also reside on a removable program medium and loaded or installed onto computer system when needed. Removable program mediums include, for example, CD-ROM, PC-CARD, USB drives, floppy disk and magnetic tape. The network interface circuit is utilized to send and receive data over a network connected to other computer systems. An interface card or similar device and appropriate software implemented by microprocessor can be utilized to connect the computer system to an existing network and transfer data according to standard protocols.

### E. Description of Example Embodiments.

An example legacy synchronous communication system generally includes a communications module configured to establish communications with a host server, a recognition module configured to identify the green screen objects in the data stream from the host and transform them into XML object, and a render module configured to present the XML objects through a browser on a user's computing device. The user's computing device (also referred to herein as a “client”) may be any computing device which supports a web browser, including, without limitation, desktop and notebook computers, workstations, and mobile devices, such as smartphones and tablet computers.

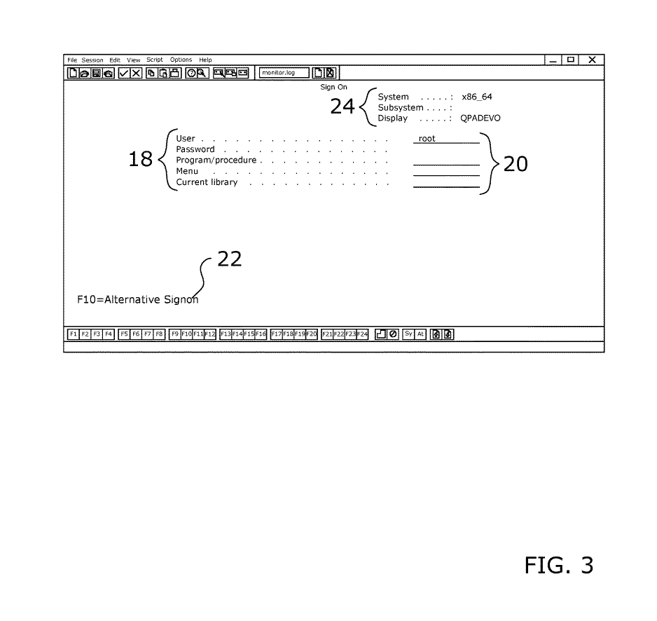

FIG. 3 is a simplified block diagram of a legacy synchronous communication system 100 in accordance with an example embodiment. The system includes a communications module or engine (“Infinite Cloud Communications Module”) 200 providing a secure portal to the host 10 application environment and configured to establish communications with the synchronous 5250 formatted data stream from the host 10. The system 100 also includes a recognition module 300, configured to identify the green screen objects in the data stream from the host 10 and transform them into XML objects, and a render module 400 configured to deploy the XML objects through a client browser 14 on a user's computing device. The system 100 operates on the data stream in real time, with little or no significant delay noticeable by the end user.

The Infinite Cloud Communications Module 200 toolset includes software products and proprietary services. The software products described as a toolset include a capture/read engine, a deployment environment and implementation services.

The Infinite Communications engine 200 automates the process required to allow legacy IBM I data streams to be captured and read so they can execute on the Apache/Tomcat platform. The data stream is dynamically captured and read so that it can be interpreted by Apache/Tomcat using the Infinite Cloud Communications Module 200 translation set.

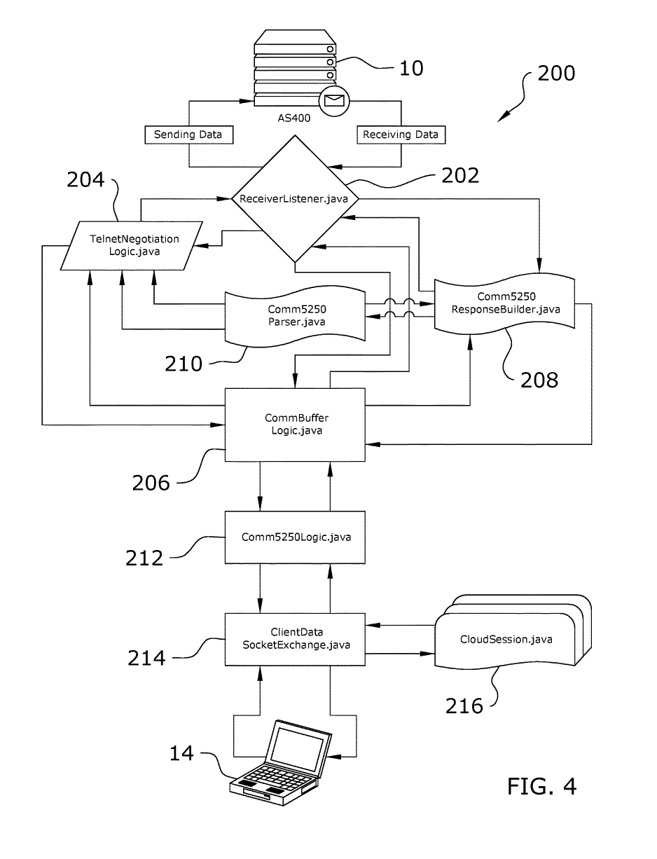

The Infinite Cloud Communication module 200 is best described as a spider web. Each part of the program must have access to other parts of the program to hold it together and establish a basis of States, Content awareness, and Settings. The first part of the communication module 200 is the negotiation. The negotiation takes place in the class called “TelnetNegotiationLogic.java” 204 (see FIG. 4). The purpose of negotiation is to create a connection to the server and establish a set of rules for each side of the connection. For example, one of the settings in the data stream is 27×132 or 24×80 support. During negotiation, the client 14 must verify with the server that the server sends the fields in a screen size supported by the client 14. If the server sends fields organized in the wrong fashion (screen size), the fields will be parsed incorrectly or may seem corrupted. There are many settings that accommodate the initial negotiation, the screen size is just one of them. The next step after negotiation is to notify that the screen is ready for fields. When the server finally sends the fields to the client 14, the client must read the metadata and determine what to do. After retrieving the fields, Infinite Cloud parses the data into a more recognizable format, then sends it to the browser for rendering. At this point, the client 14 is in a stable connection with the server 100, actively navigating from page to page. When client/server is in a state where they are actively sending and receiving fields (as in the previous sentence), the server 100 can also send miscellaneous information to the client 14. For example, one of the issues that all of the previous versions of Infinite Cloud has had, was the ability to receive messages in the form of a notification. Since in past days the connection from Infinite Cloud to the browser was used in a disconnected architecture, it was impossible for the Infinite Cloud Server 100 to send a message to the browser, since the browser always had to request something first. Recently, we have made the switch from a disconnected architecture, to a connected architecture, so that these notifications can be sent synchronously between the Infinite Cloud Server 100 and the browser 14. This will be of use with the message light indicator that was used on AS400 clients to inform the user that there is a message waiting for them as soon as they press the next AID key (Attention Identifier Key is a key such as Enter, F1, F2, Clear, PageUp, etc.). Similarly, it will be of even more use due to the fact that the browser 14 can now be simultaneously updated to the server's metadata since it is not mandatory that the browser 14 creates a request before Infinite Cloud sends it a message, or in this case, a notification. Now that we have a small foundation of what Infinite Cloud does, let's move on to describing the system in a more technical aspect.

FIG. 4 illustrates the major Java® classes that may be used in one embodiment of the communications module 200 to organize the data stream from the synchronous host 10. The classes may include:
ReceiverListener.java 202 to listen for the data stream coming from the AS400 10.
TelnetNegotiationLogic.java 204 to perform a negotiation between the AS400 10 and the Infinite Cloud Server 100 to retrieve settings such as the supported screen size.
CommBufferLogic.java 206 to hold most of the settings that the server/client establishes during the initial negotiation. All classes must see this class so that they can act accordingly with the correct settings.
Comm5250ResponseBuilder.java 208 to respond to the instructions in Comm5250Parser 210 and execute the actions that were not performed in Comm5250Parser 210.
Comm5250Parser.java 210 to parse the information into classes rather than a stream of bytes and decide what to do but without actually performing the actions.
Comm5250Logic.java 212 to establish an initial connections to the AS400 10 and acts as a middleman for the rest of the classes' interactions between the AS400 Server and the Infinite Cloud Server 100.
ClientDataSocketExchange.java 214 (formerly a servlet in previous versions) to allow a connected architecture between the Infinite Cloud Server 100 and the Browser 14.
CloudSession.java 216 to hold the session information for tracking the recognition between different users logged into the system.
TelnetCommandValue.java to hold values that help the programmer and Server 100 decide between actions based on the bytes sent from the AS400 10.

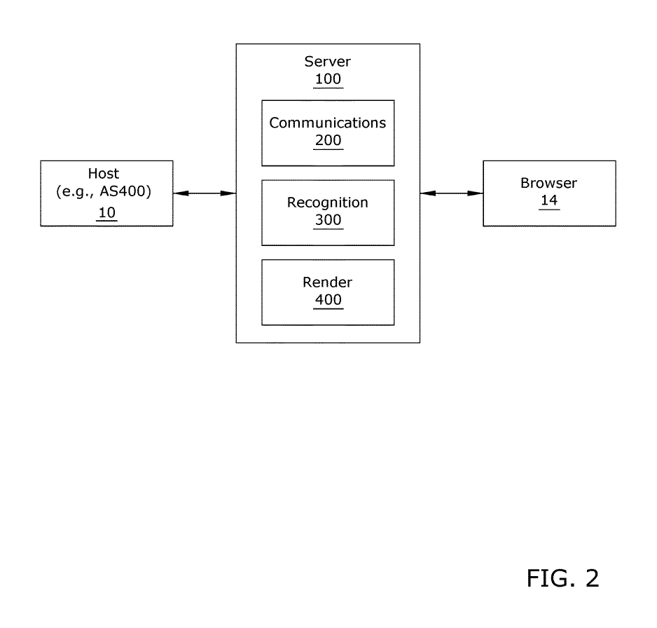

The recognition module 300 is configured to identify the green screen objects in the data stream received from the host 10 and transform them into XML objects that can be rendered on the client browser 14. Referring back to FIG. 2, the green screen 16 displayed on the terminal 12 displays information as colored text. The screen 16 of FIG. 2 displays a log in screen and objects include a list of items 18 identifying information that the user is to input. The objects also include lines 20 on which the user types the entries. Other objects include the action that will result when a function key is pressed 22 some system information 24.

After the connection to the host 10 is established, the recognition module 300 read the incoming data stream. Through the use of Java scripts or agents, the recognition module 300 identifies the objects that are to be displayed and translates them into XML objects that can be rendered and natively displayed graphically on a web browser 14. Different agents are configured to process different objects. For example, there are separate agents to process titles, menu options, function keys, buttons, dates, and information retrieved from a database, among others. The objects are mapped to predetermined locations on the graphical screen, as determined by one or more templates populated by the XML objects.

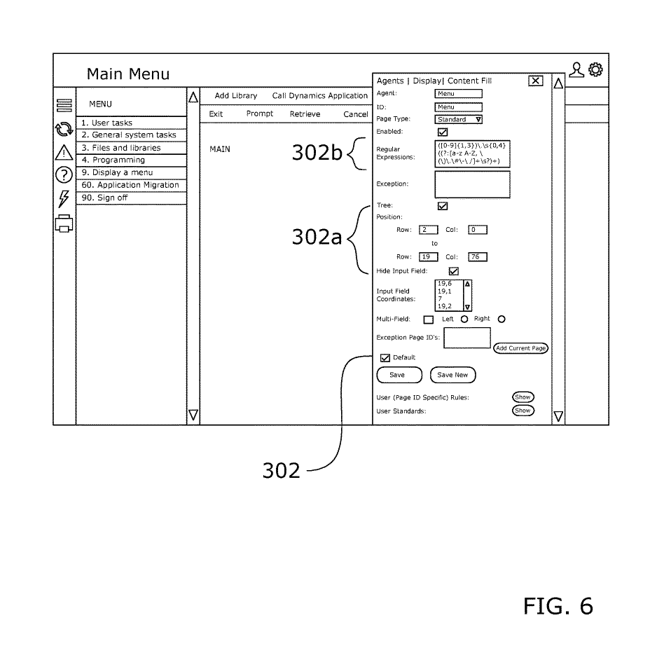

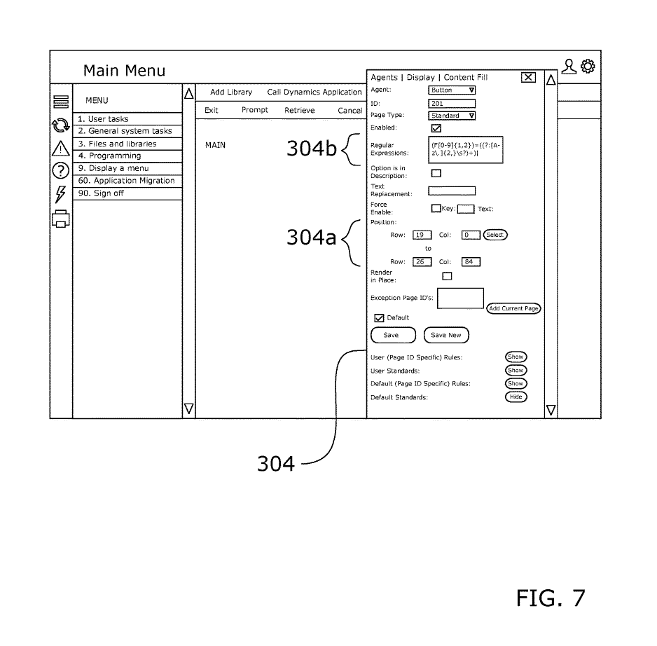

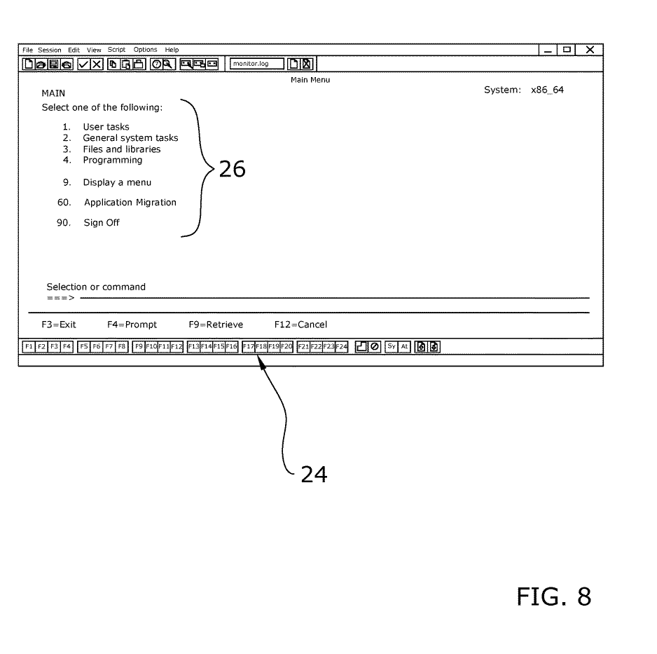

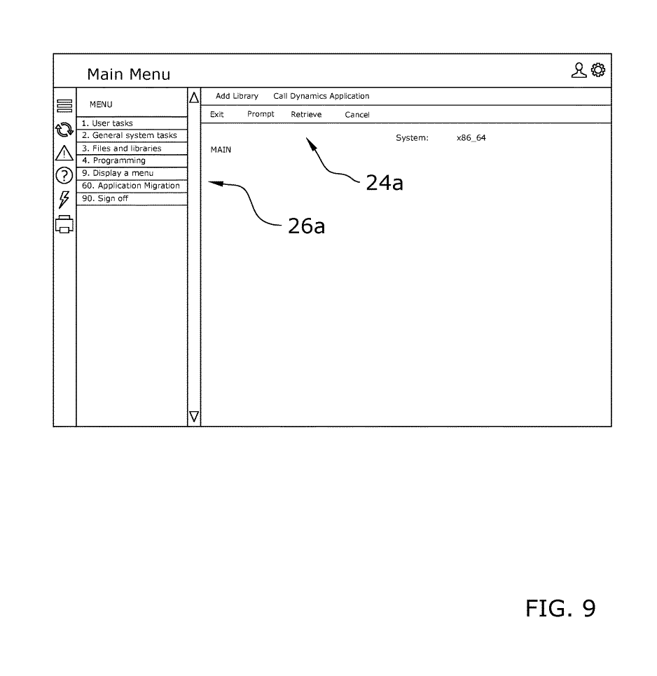

FIGS. 6 and 7 are screen shots of panels that allow a user to establish and customize agent settings for menus 302 and buttons 304, respectively. Each of the objects on the green screen 16 is located at a particular set of coordinates on the screen 16. The agent “looks” for objects within a particular range of coordinates, defined by rows and columns 302A, 304A. The agent also determines what occupies the defined range—such as numbers, letters, other characters, etc. That is, the agent looks for specific patterns based on predefined or user-modified expressions 302B, 304B. For example, green screen function keys 24 (FIG. 8) may be represented graphically as buttons 24A (FIG. 9) that a user may click on to perform the functions, such as exit the screen, as if the function key on a terminal 12 was actually pressed. Thus, when the user clicks on the word “EXIT” (FIG. 9) the recognition module 300 recognizes that as the equivalent of pressing the “F3” key on the green screen (FIG. 8) and transmits the appropriate signal to the host 10. Similarly, green screen menu items 26 may be represented graphically as menu items 26A that the user may select by pointing and clicking instead of entering a number. The recognition module 300 translates the click into a number as if on the green screen menu and transmits the appropriate signal to the host 10. Similarly, function keys to page forward or back may be mapped to clickable right and left arrow buttons.

The templates into which the green screen objects are mapped as XML objects may be standard templates or templates specifically custom designed for a particular customer. Characteristics of the templates are also defined by agents and may include background color, background graphics, text color, text fonts, changes in text color in response to a cursor hovering over the text, among others. The results are attractive browser screens that have a look, feel, and function that are familiar to most users, in contrast to unattractive and unfriendly green screens.

It is also possible for a template to embed other web components, including live internet windows such as a live stock trading screen, for example. And, being java-based, access to other applications may be incorporated into the display, including those running on large-scale and enterprise architectures, such provided by SAP for example.

The agents are universal in that each applies to all screens. Both the recognition and the rendering are global. Consequently, it is not necessary to undergo the time consuming separate coding of each green screen. Moreover, because processing of the green screens is performed at the server 100, it is not necessary to install any software on each client. Processing is performed quickly, with no noticeable delay. Additionally, because the system 100 is Java-based, it is not platform dependent as other methods are; rather, a user may access the host 10 though the system 100 from any device capable of running a browser.

### F. Operation of Preferred Embodiment.

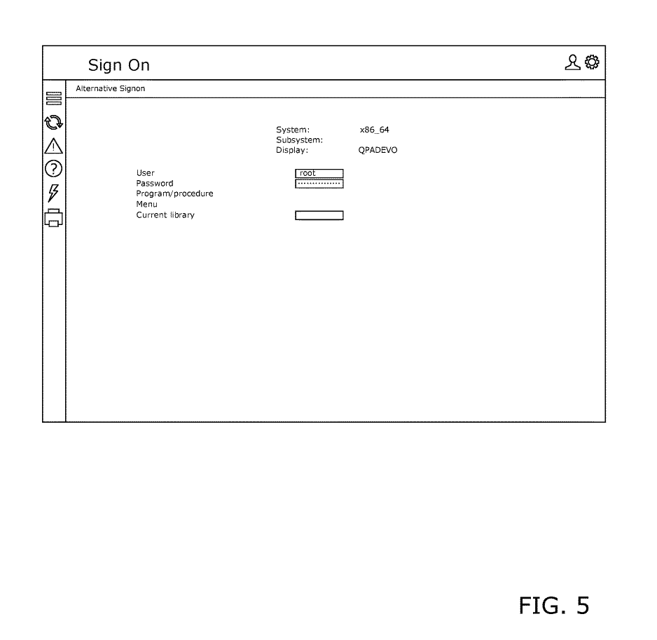

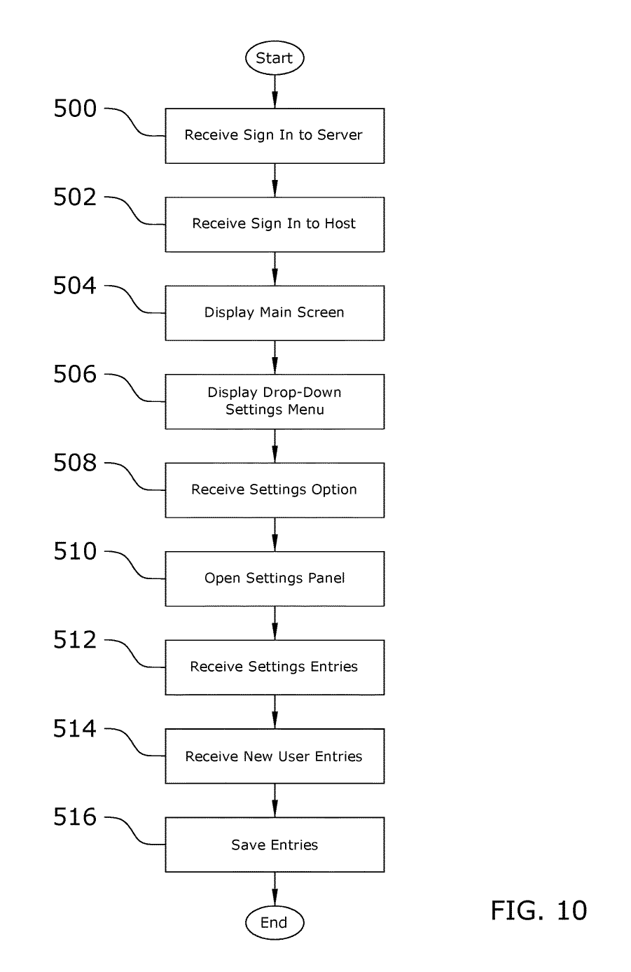

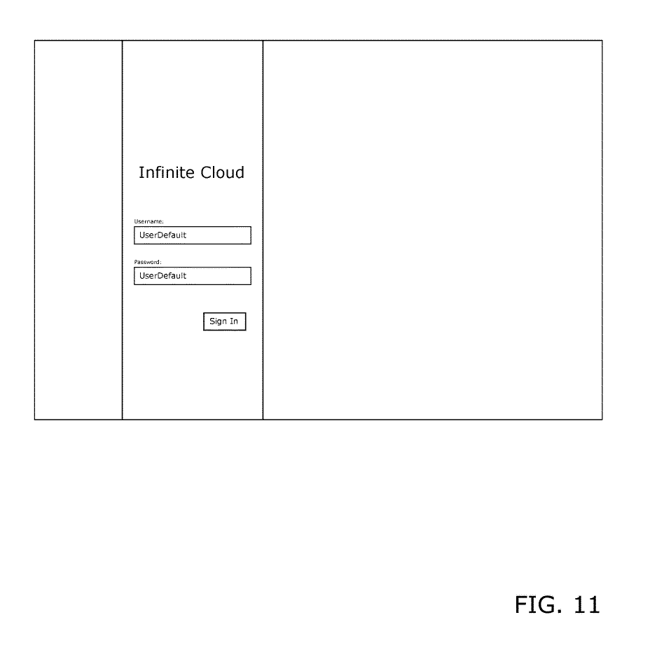

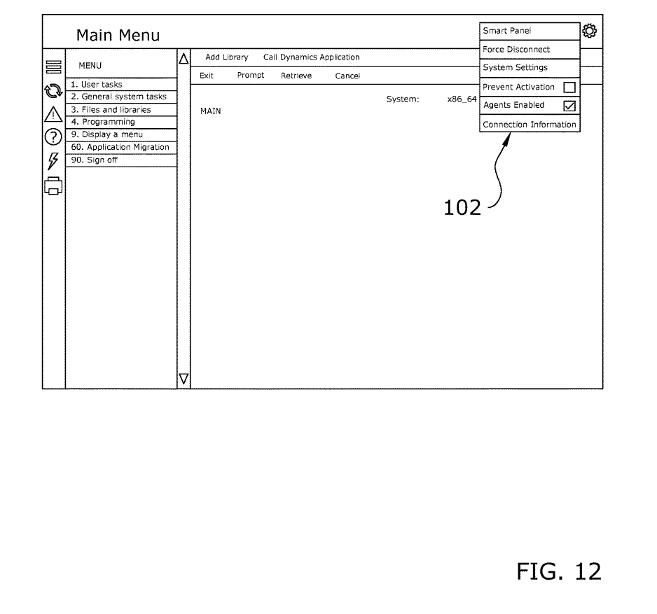

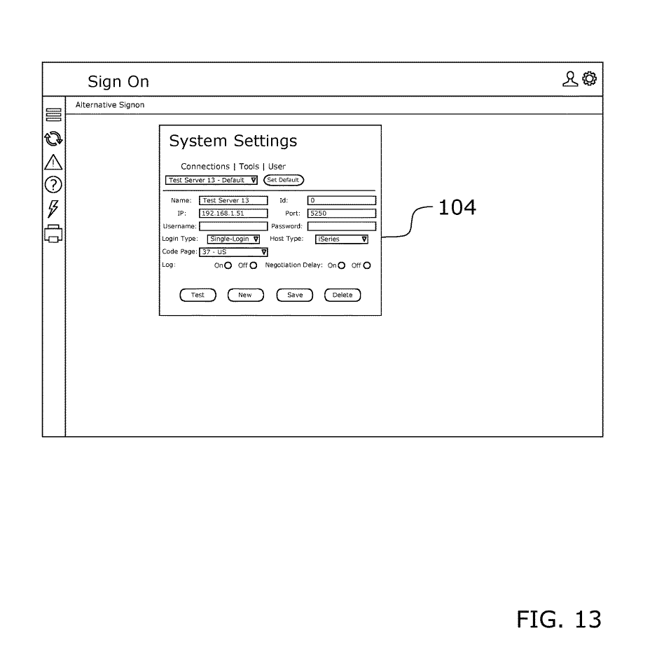

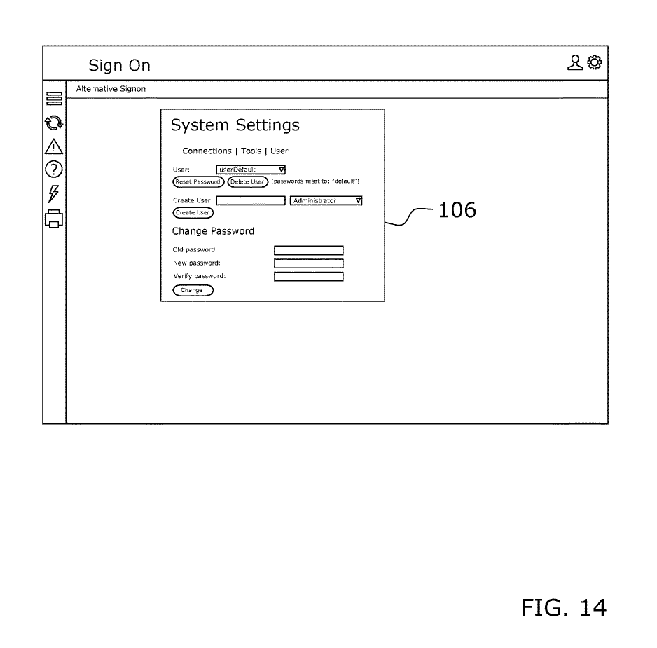

The set-up of the legacy synchronous communication system 100 will now be described with reference to the flowchart of FIG. 10 and the various screen shots illustrated in the Figures. An administrator first signs into the system 100 (FIG. 10, step 500; FIG. 11) and then signs into the host 10 (step 502; FIG. 5). A screen such as that shown in FIG. 9 is displayed (step 504). When the gear icon is selected, a drop-down menu 102 is presented (step 506; FIG. 12) from which the administrator may select the system settings option (step 508) and a systems settings panel 104 opens (step 510; FIG. 13). The administrator may then enter the appropriate information (step 512) to enable the host 10 and the server 100 to communicate. By repeating the process, parameters to enable connections with additional hosts may be entered, each with a unique connection name. The administrator may also enter information in another panel 106 (step 514; FIG. 14) to enable one or more new users to access the system 100. All of the information may then be saved (step 516).

If desired, predefined agents may be modified and new agents created by selecting the smart panel option on the drop-down menu 102 (step 518). Specific agents may be selected to open agent panels, such as the panels 302, 304 illustrated in FIGS. 6 and 7. Information may be entered or modified (step 520) and saved (step 522).

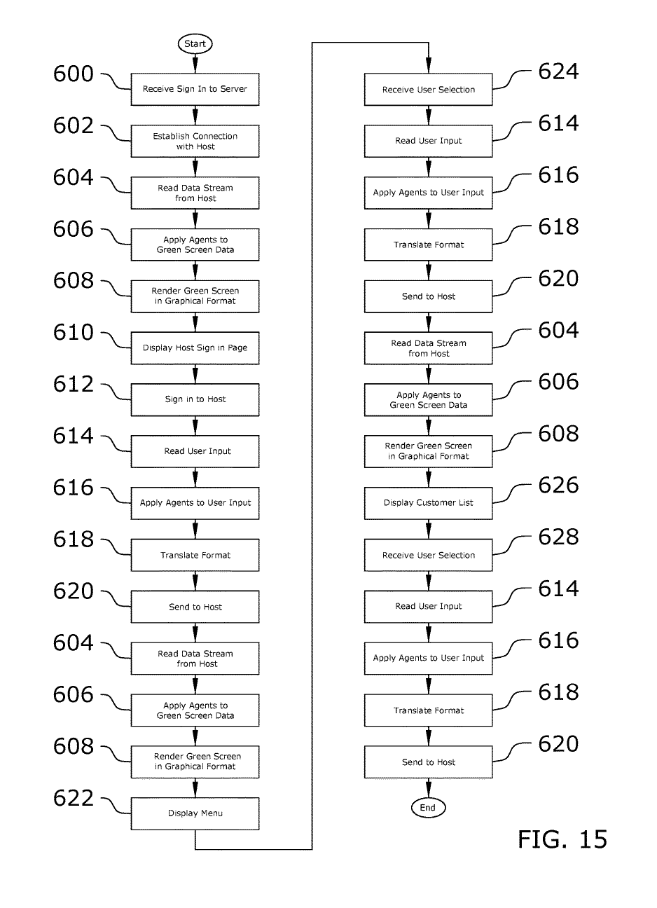

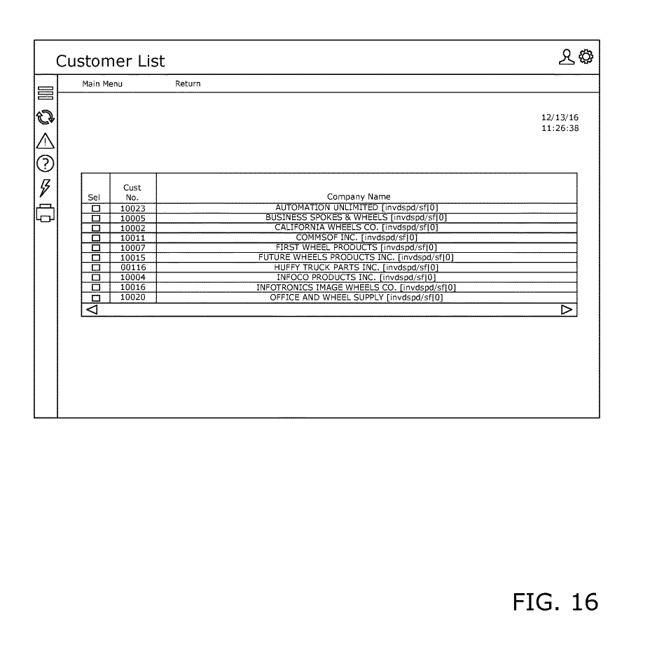

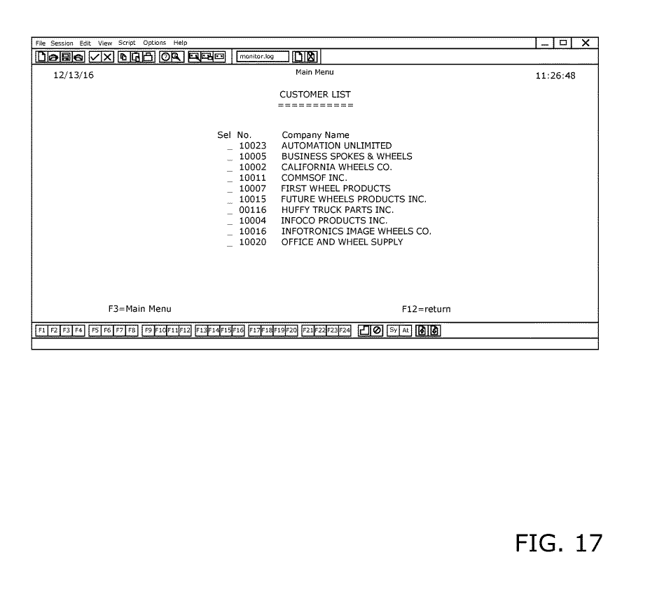

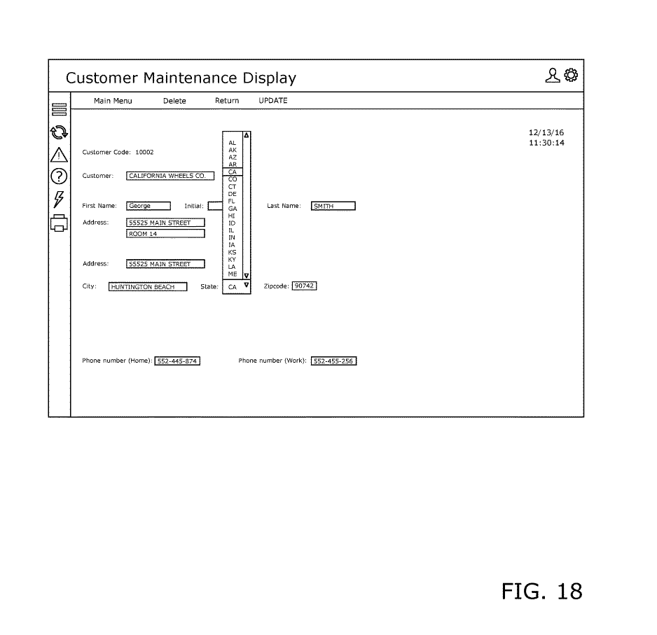

FIG. 15 is a flowchart of a method by which an end user of the system 100 may access the host 10 through a web-based browser client 14. As before, the user signs into the server 100 (FIG. 15, step 600; FIG. 11). The communications module 200 establishes a secure connection with the host 10 (step 602) and the recognition module 300 reads the data stream from the host 10 (step 604), applies the agents to the data stream (step 606), renders what would be the green screen in graphical format (step 608) for display on the user's browser (step 610). The user then signs into the host 10 (step 612; FIG. 5) and the user's input is read by the recognition module 300 (step 614). The agents are applied in reverse to the input (step 616), translated into the appropriate data format (step 618), and transmitted to the host 10 (step 620). The host 10 responds and the resulting green screen menu is processed, recognized and rendered (as in steps 604-608) and displayed as a graphical screen such as that shown in FIG. 9 (step 622). From this screen, the user may select any of the options 24A, 26A presented along the top or side (step 624). After the selections are made from the menu, the user's input is processed and transmitted to the host 10 (as in steps 614-620). For example, the user may enter the appropriate selections to display a customer list and, in response (steps 604-608), a list such as that illustrated in FIG. 16 is displayed (step 626). For comparison, the equivalent green screen that would be displayed on the terminal 12 is illustrated in FIG. 17. To view information about a particular customer, the user may click on the selection box to the left of the desired customer (step 628) and a screen such as that shown in FIG. 18 is displayed. As before, the user's input is processed and sent to the host 10 (steps 614-620). FIG. 18 also illustrates that an agent may define the properties of a drop-down menu, such as one used to select a state. All data from the host 10 is processed as described above (steps 604-608) and all input from the user is processed as described above (steps 614-620).

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

At least one embodiment of the legacy synchronous communication system is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, the computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the legacy synchronous communication system will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the legacy synchronous communication system, suitable methods and materials are described above. Thus, the legacy synchronous communication system is not intended to be limited to the embodiments shown, but is to be accorded the widest scope consistent with the principles and features disclosed herein.

What is claimed is:

1. A legacy synchronous communication system, comprising:
a communication module configured to establish communication with a host server;
a recognition module configured to identify green screen objects in a synchronous data stream from the host server and generate corresponding asynchronous XML objects; and
a render module configured to present the XML objects through a browser on a user's computing device.

2. The system of claim 1, wherein the synchronous data stream comprises a 5250 formatted data stream.

3. The system of claim 1, wherein the host server comprises an IBM AS400 computer.

4. The system of claim 1, wherein the recognition module comprises a plurality of agents, each configured to:
identify a predetermined green screen object in the data stream; and
translate the green screen object into an XML object.

5. The system of claim 4, wherein the plurality of agents comprise agents configured to recognize in the green screen objects representing at least titles, menu options, function keys, buttons, dates, and information retrieved from a database.

6. The system of claim 4, wherein each agent is configured to identify green screen objects located only within a predefined area of the green screen.

7. The system of claim 4, wherein the render module is configured to:
receive the XML objects from the recognition module;
populate a template with apply the XML objects; and
render the filled template in the user's browser.

8. The system of claim 7, wherein the template comprises predefined locations for each XML object.

9. A method of displaying green screen objects in a browser, comprising:
reading a synchronous data stream received from a host;
applying a plurality of agents to the data stream;
recognizing green screen objects in the data stream;
converting the green screen objects into corresponding XML objects; and
displaying the XML objects in a browser of the user.

10. The method of claim 9, further comprising, before reading the synchronous data stream:
receiving host sign-in information from a user; and
establishing a data connection with the host.

11. The method of claim 9, wherein displaying the XML objects comprises:
populating a predefined template with the XML objects; and
displaying the populated template in the browser.

12. The method of claim 11 wherein the template comprises predefined locations for each XML object.

13. The method of claim 9, wherein applying the plurality to the data stream comprises applying the plurality of agents to recognize green screen objects representing at least titles, menu options, function keys, buttons, dates, and information retrieved from a database.

14. The method of claim 9, wherein applying the plurality to the data stream comprises applying each agent to green screen objects located only within a predefined area of the green screen.

15. The method of claim 9, wherein the synchronous data stream comprises a 5250 formatted data stream.

16. The method of claim 9, wherein the host server comprises an IBM AS400 computer.
